(19) United States
(12) Patent Application Publication
(10) Pub. No.: US 2005/0202806 A1
(43) Pub. Date: Sep. 15, 2005

(54) AUTOMATIC CONFERENCE CALL REPLAY

(75) Inventors: Troy Bourgeois, Apex, NC (US); Brett Anthony Pantalone, Willow Spring, NC (US)

Correspondence Address: MOORE & VAN ALLEN PLLC, P.O. BOX 13706, Research Triangle Park, NC, 27709, US

(73) Assignee: Sony Ericsson Mobile Communications AB, Lund (SE)

(21) Appl. No.: 10/708,526

(22) Filed: Mar. 10, 2004

(51) Int. Cl. H04M 3/42

(52) U.S. Cl. 455/416; 455/414.1

(57) ABSTRACT

A way of storing and forwarding the content of a cellular conference call is described. A conference call is conducted among a group. The network is responsible for recording and storing the conference call. The network also determines which mobile telephone devices associated with group members did not participate in the conference call. The network automatically composes and sends a message to the mobile telephone devices of the group members that did not participate in the conference call. The message contains information indicating that a conference call took place and is available to be downloaded from the network for replay. In another implementation, a mobile telephone is responsible for recording and storing the conference call. The mobile telephone also determines which mobile telephone devices did not participate in the conference call. The mobile telephone device composes and sends an MMS message to the group members that did not participate in the conference call. The message contains information indicating that a conference call took place and includes an audio attachment of the conference call.

### BACKGROUND OF INVENTION

Today, many companies use Push-to-Talk (PTT) radio/mobile phone solutions to communicate as opposed to typical cellular phone calls. PTT allows a group of people to stay up-to-date on developing events, maximizing efficiency within the organization. A problem that can occur in conference mode PTT communication, however, is that some members of the group may not detect initiation of a PTT conference call. This can happen for a variety of reasons including out-of-service-range, radio turned off, already on call, or presence information marked as “unavailable”. These group members can miss out on critical information or could have vital information for the group but not know that it was needed. When one or more group members miss out on a conference call, it is important that they receive the benefit of the discussion as soon as possible. The sooner that unavailable group members become aware of the content of a conference call, the quicker they can respond to issues or items raised in the conference call.

What is needed is a means for notifying unavailable group members that a conference call took place and provide them with a recorded copy of the conference call in a fast and efficient manner.

### SUMMARY OF INVENTION

The present invention describes a method of storing and forwarding the content of a conference call within the infrastructure of a mobile telephone network and alternatively within a mobile telephone device. For the network implementation and in response to a request by a group member, a conference call is initiated on the mobile telephone network among a specified group of mobile telephone device users. The network then records and stores the conference call within the network infrastructure used to broadcast the conference call. The network also determines which mobile telephone devices associated with group members did not participate in the conference call. Upon completion of the conference call, the network automatically composes and sends a conference call notification message to the mobile telephone devices of the group members that did not participate in the conference call. The message contains information indicating that a conference call took place and is available to be downloaded from the network to the mobile telephone devices for replay.

For the mobile telephone device implementation, a mobile telephone device initiates a conference call on a mobile telephone network among a specified group of mobile telephone device users. The mobile telephone device records and stores the conference call in internal memory. The mobile telephone device also determines which mobile telephone devices associated with group members did not participate in the conference call. The mobile telephone device then composes and sends a conference call notification MMS message to the mobile telephone devices of the group members that did not participate in the conference call. The MMS message indicates that a conference call took place and contains an audio attachment of the conference call.

### BRIEF DESCRIPTION OF DRAWINGS

FIG. 1 is a block diagram of components that are utilized in the present invention.

FIG. 2 is a flowchart detailing a method of carrying out of the present invention.

FIG. 3 is an alternative block diagram of components that are utilized in the present invention.

FIG. 4 is a flowchart detailing an alternative method of carrying out of the present invention.

### DETAILED DESCRIPTION

A solution to the problem described above relating to group members missing out on a conference call can be approached in a couple of different ways. One way is to focus the logic and intelligence of the conference call replay system within the network infrastructure of the mobile phone network. Another way is to put the onus on the group member that initiated the conference call. More accurately, the onus is put on that group member's mobile telephone device in conjunction with the network infrastructure. Each solution has its advantages and is presented herein.

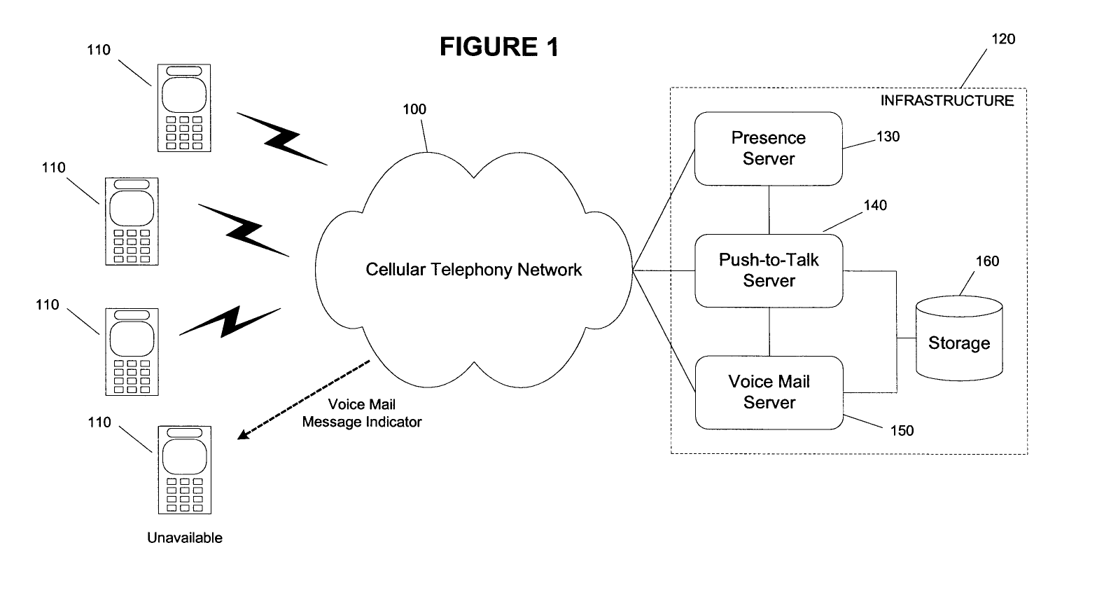

The former solution can be termed the network server solution since the network is almost solely responsible for carrying out the solution. FIG. 1 is a block diagram of components that are utilized in the present invention. A mobile cellular telephony network 100 is shown facilitating communication among several mobile telephone devices 110. A box 120 labeled infrastructure shows a portion of the mobile cellular telephony network's 100 infrastructure that is used to carry out the functions of the present invention. Within the infrastructure box 120 are several computer servers 130, 140, 150 serving different functions and a storage device 160 for containing data. There is a presence server 130 for determining who is and is not currently on the network. There is a push-to-talk server 140 for facilitating instantaneous two-way radio conversations among network users. And, there is a voice mail server 150 for controlling the network users voice mail functions. The servers are separately shown simply to describe and refer to the functions carried out by each. The actual computer hardware that handles the functions described may be integrated into fewer hardware devices or even spread out over more hardware devices. The hardware may also be spread over other networks that are not necessarily controlled by the cellular operator.

For illustrative purposes, one of the mobile telephone devices shown in FIG. 1 is labeled “unavailable” to indicate that it is a member of the group but is not participating in a conference call for one reason or another.

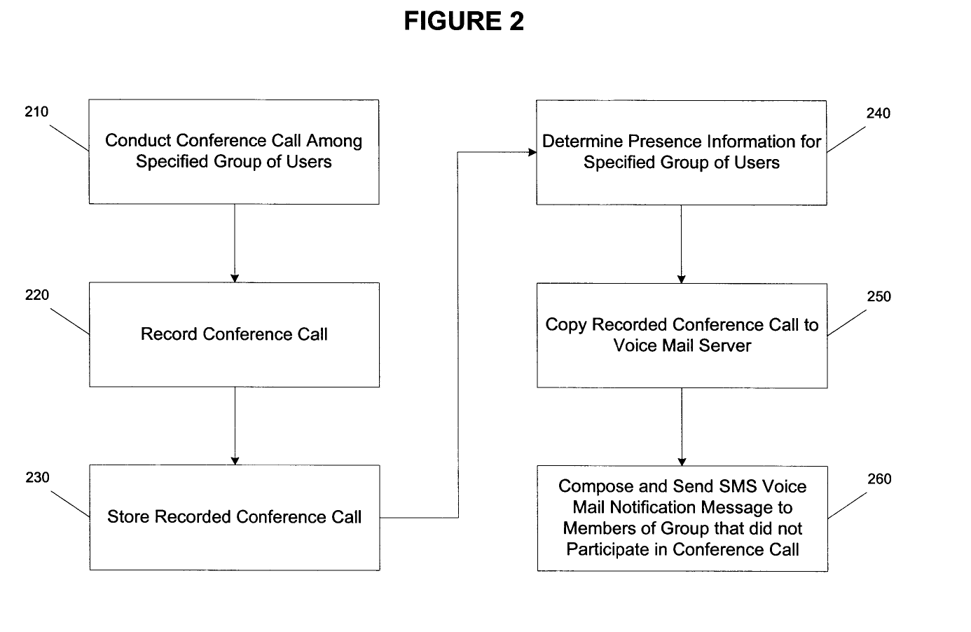

FIG. 2 is a flowchart detailing a method of carrying out the network solution of the present invention. While the steps in the logic diagram in FIG. 2 appear to be presented in chronological order, some of the steps may occur at various instances while others may occur simultaneously. The figure serves to illustrate the functions of the present invention. Implementation of the functions, specifically the timing of the functions, can vary without affecting the parameters of the present invention.

The first step is to initiate and conduct a conference call among a specified group of mobile phone users 210. A conference call can be initiated by a single user. The user will typically select a group of other mobile phone users to participate in the conference call. The initiating mobile phone user's mobile phone internal contact database contains individual and/or group entries that can be selected. Once the initiating user selects the participants for a conference call, an attempt to contact each member is made over the network. Those able and willing to respond are joined into the conference call using push-to-talk technology.

The initiating mobile phone user also signals the network that the conference call is to be recorded. The push-to-talk server records 220 the conference call and stores 230 it on disk within the network infrastructure. This step involves the capture and concatenation of each voice packet until the conference call session is ended. The result will be a single voice file that is stored on disk. Alternatively, the voice information can be saved as a series of short monologues, one for each change of the floor. Each monologue file can then be stamped with the identity of the speaker before being saved.

The network presence server determines and informs the push-to-talk server which of the requested individuals were unavailable for the conference call 240. The push-to-talk server can be interfaced with the voice mail system. The recorded voice file is then transferred to the voice mail server 250, and copied into the mailboxes of every unavailable user. When the user again becomes available, she will receive an SMS notification 260 of a new voice mail message, and can listen to the entire recorded conference call at her convenience.

This solution minimizes cost to the mobile telephone device, thereby making its adaptation by the end-user faster. The mobile telephone device need not be augmented with new hardware or software since the intelligence of the present invention for this embodiment is housed within the network infrastructure. Use is made of the existing voice mail service to give unavailable group members access to a previously conducted conference call.

The other solution mentioned above can be termed the client terminal solution since a group member's mobile telephone device is primarily responsible for carrying out the solution.

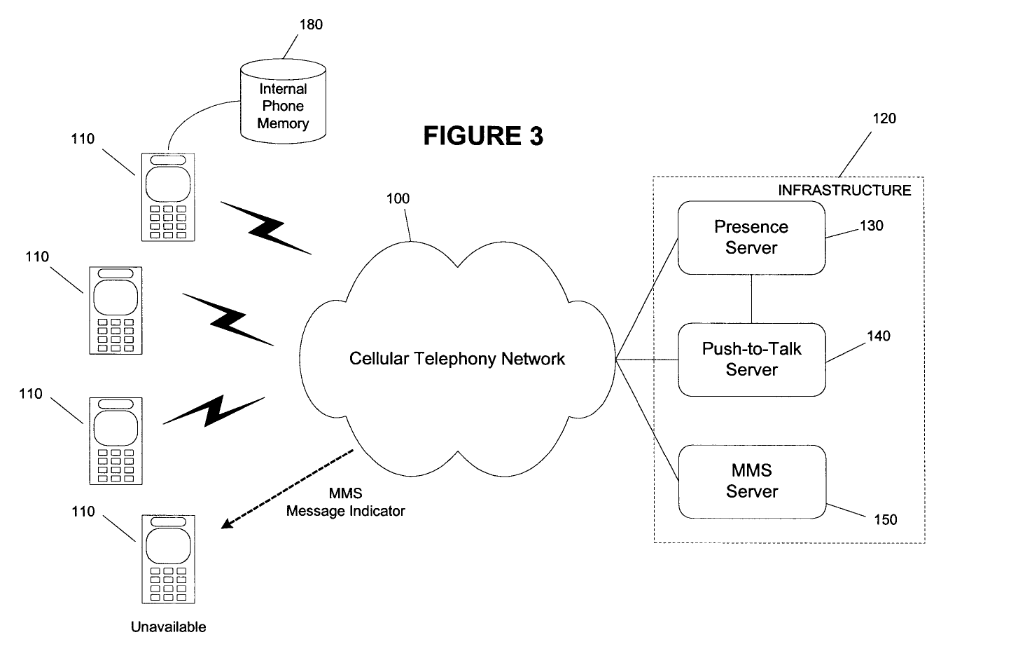

FIG. 3 is an alternative block diagram of components that are utilized in the present invention. This time the storage device that was contained within the network infrastructure has been omitted in favor of recording and storing the conference call on the mobile telephone device of the initiating group member. This may necessitate a larger than normal storage capacity 180 for the mobile telephone device since it may be called upon to record and store larger amounts of voice data resulting from a conference call. The environment and configuration of the network with respect to conducting a conference call remains unchanged from that shown in and described by FIG. 1. The differences involve where the conference call is recorded and who is responsible for notifying unavailable members as to its existence and content.

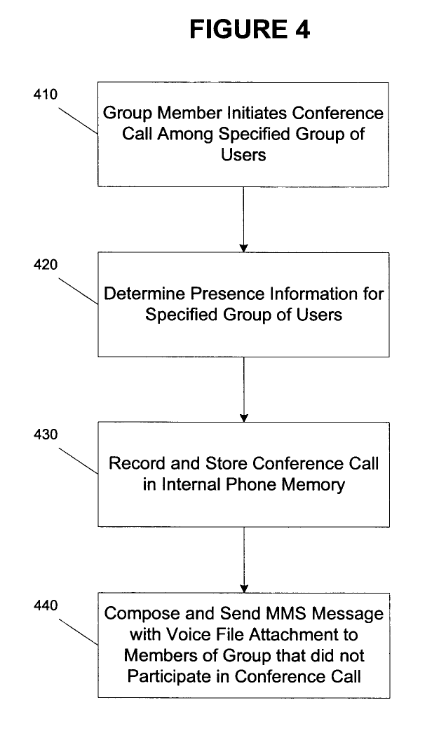

To that end, FIG. 4 is a flowchart detailing this alternative method of carrying out of the present invention. A group member again initiates a conference call 410 with a specified group. The initiator's mobile telephone device possesses the intelligence and memory to track group members and their relationships to queued recordings. When a push-to-talk conference call session begins, the initiator determines and logs—via presence information—which group members are unavailable 420. The initiator's mobile telephone device then records the conference call and stores the resulting file in non-volatile (Flash) or RAM memory on his mobile phone device 430. At the end of the conference call, the mobile telephone device composes and forwards the recorded voice file as an MMS message to the unavailable users 440.

If desired, the recorded file can be safely deleted from the initiator's mobile telephone device memory, because the MMS server will queue the message for the recipients. As an alternative, the initiator's mobile telephone device user interface can monitor the presence status of the unavailable users, and inform the initiator as they become available. The initiator can then decide to forward the recorded voice file, call the user, initiate a new conference call session, etc.

This solution also allows for a relatively simple implementation to the market without system-to-phone compatibility concerns. More memory inside each mobile telephone device would be required with a protocol to manage the memory limitations (i.e. disposition of older, saved recordings).

An acknowledgment feature can be added as an additional feature. The initiator of the conference call, a supervisor and/or key members (as identified by a group definition) can receive a text message “return receipt” when individual group members have received the delayed recording. This can be done for both implementations, and can be implemented by the voice mail server or MMS server, respectively.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

1. Within the infrastructure of a mobile telephone network, a method of storing and forwarding the content of a conference call comprising:
in response to a request by a group member, initiating a conference call on the mobile telephone network among a specified group of mobile telephone devices;
recording the conference call within the network infrastructure of the mobile telephone network used to broadcast the conference call;
storing the conference call on a storage medium within the network infrastructure used to broadcast the conference call;
determining which mobile telephone devices did not participate in the conference call; and
composing and sending a conference call notification message to the mobile telephone devices that did not participate in the conference call, the message comprised of information indicating that a conference call took place and is available to be downloaded from the mobile telephone network to the mobile telephone devices for replay.

2. Within the infrastructure of a mobile telephone network, a system for storing and forwarding the content of a conference call comprising:
in response to a request by a group member, means for initiating a conference call on the mobile telephone network among a specified group of mobile telephone devices;
means for recording the conference call within the network infrastructure of the mobile telephone network used to broadcast the conference call;
means for storing the conference call on a storage medium within the network infrastructure used to broadcast the conference call;
means for determining which mobile telephone devices did not participate in the conference call; and
means for composing and sending a conference call notification message to the mobile telephone devices that did not participate in the conference call, the message comprised of information indicating that a conference call took place and is available to be downloaded from the mobile telephone network to the mobile telephone devices for replay.

3. Within the infrastructure of a mobile telephone network, a computer program product for storing and forwarding the content of a conference call comprising:
in response to a request by a group member, computer program code for initiating a conference call on the mobile telephone network among a specified group of mobile telephone devices;
computer program code for recording the conference call within the network infrastructure of the mobile telephone network used to broadcast the conference call;
computer program code for storing the conference call on a storage medium within the network infrastructure used to broadcast the conference call;
computer program code for determining which mobile telephone devices did not participate in the conference call; and
computer program code for composing and sending a conference call notification message to the mobile telephone devices that did not participate in the conference call, the message comprised of information indicating that a conference call took place and is available to be downloaded from the mobile telephone network to the mobile telephone devices for replay.

4. Within a mobile telephone device, a method of storing and forwarding the content of a conference call comprising:
initiating a conference call on a mobile telephone network among a specified group of mobile telephone devices;
recording and storing the conference call in memory on one of the mobile telephone devices;
determining which mobile telephone devices did not participate in the conference call; and
composing and sending a conference call notification MMS message to the mobile telephone devices that did not participate in the conference call, the message comprised of information indicating that a conference call took place and containing an audio attachment of the conference call.

5. Within a mobile telephone device, a system for storing and forwarding the content of a conference call comprising:
means for initiating a conference call on a mobile telephone network among a specified group of mobile telephone devices;
means for recording and storing the conference call in memory on one of the mobile telephone devices;
means for determining which mobile telephone devices did not participate in the conference call; and
means for composing and sending a conference call notification MMS message to the mobile telephone devices that did not participate in the conference call, the message comprised of information indicating that a conference call took place and containing an audio attachment of the conference call.

6. Within a mobile telephone device, a computer program product for storing and forwarding the content of a conference call comprising:
computer program code for initiating a conference call on a mobile telephone network among a specified group of mobile telephone devices;
computer program code for recording and storing the conference call in memory on one of the mobile telephone devices;
computer program code for determining which mobile telephone devices did not participate in the conference call; and
computer program code for composing and sending a conference call notification MMS message to the mobile telephone devices that did not participate in the conference call, the message comprised of information indicating that a conference call took place and containing an audio attachment of the conference call.
